(19) United States
(12) Patent Application Publication
(10) Pub. No.: US 2017/0225223 A1
(43) Pub. Date: Aug. 10, 2017

(54) CASTING MOLD HAVING AT LEAST ONE CAVITY FOR MANUFACTURING AT LEAST ONE CAST ARTICLE

(71) Applicant: Volkswagen Aktiengesellschaft, Wolfsburg (DE)

(72) Inventors: Thomas BEGANOVIC, Celle (DE); Carsten DEMMER, Braunschweig (DE); Sebastian GIERTH, Ringenhain (DE); Rafael KUCHARSKI, Hannover (DE); Sebastian FINDEISEN, Braunschweig (DE); Stephan KNORR, Braunschweig (DE)

(73) Assignee: Volkswagen Aktiengesellschaft, Wolfsburg (DE)

(21) Appl. No.: 15/498,531

(22) Filed: Apr. 27, 2017

Related U.S. Application Data
(63) Continuation of application No. PCT/EP2015/071914, filed on Sep. 23, 2015.

(30) Foreign Application Priority Data
Oct. 27, 2014 (DE) 10 2014 221 852.7

(51) Int. Cl. B22C 9/06; B23K 26/362; B22C 9/18

(52) U.S. Cl. CPC B22C 9/06; B22C 9/18; B23K 26/362; B23K 2201/04

(57) ABSTRACT

A casting mold having at least one cavity for manufacturing at least one cast article, in which at least some areas of a casting surface of the casting mold delimiting the cavity have a surface texture. The surface texture has multiple elementary cells, wherein each elementary cell has a structure that projects and/or is recessed with respect to the casting surface and ends within the applicable elementary cell. In addition, a cast article produced by the casting mold is provided.

This nonprovisional application is a continuation of International Application No. PCT/EP2015/071914, which was filed on Sep. 23, 2015, and which claims priority to German Patent Application No. 10 2014 221 852.7, which was filed in Germany on Oct. 27, 2014, and which are both herein incorporated by reference.

### BACKGROUND OF THE INVENTION

Field of the Invention

The present invention relates to a casting mold having at least one cavity for manufacturing at least one cast article, and a cast article produced by means of this casting mold.

Description of the Background Art

EP 0 106 203 A1 previously disclosed a thin-walled cast article with rib-like bumps or extensions, wherein the bumps or extensions form contiguous connecting ribs and delimit a number of fill areas. During the casting process, the melt flows into the fill areas from four directions through the straight ribs extending vertically and horizontally so that said areas are filled rapidly. In this way, cold shuts can be prevented efficaciously. Suitable uses for these cast articles are for housings and wheels in the automotive industry.

At present, it is only possible to realize cast articles with wall thicknesses above 5 mm in the mass production of lightweight chassis parts from aluminum alloys, especially when flow paths of the aluminum melt are relatively large. This is a result of the surface tension of the metal melt and the oxide film forming on the melt front, especially when flow paths are relatively long. Consequently, solely for casting reasons, subsections of the chassis part have greater wall thicknesses than absolutely necessary. This results in higher material usage along with an increased weight, which is very disadvantageous, in particular with regard to lightweight construction. In order to optimize flow paths and velocities, a coating known as mold wash is applied to the casting surfaces, which roughens the smooth surface of the casting mold.

### SUMMARY OF THE INVENTION

It is therefore an object of the invention to provide a casting mold having a cavity by means of which cast articles with smaller wall thicknesses can be produced even with long flow paths of the metal melt.

According to an exemplary embodiment of the invention, a casting mold having at least one cavity for manufacturing at least one cast article is provided in which at least some areas of a casting surface of the casting mold delimiting the cavity have a surface texture that have multiple elementary cells, wherein each elementary cell has a structure that projects and/or is recessed with respect to the casting surface and ends within the applicable elementary cell. As a result of the fact that the projecting and/or recessed structures end within the elementary cell, each structure is completely surrounded by a web of the casting surface so that it is possible to provide a surface texture with a defined roughness as compared to the grid structure known from the prior art cited above. As a result of this intentional roughness of the surface texture, the contact area between the metal melt and the casting surface is minimized. The local velocity of the metal melt is increased by the surface texture based on local turbulent flows. The oxide film on the melt is increasingly broken up.

At the boundary zone between the structured surface of the permanent mold and the metal melt, an air layer or air cushion that has an insulating effect arises due to a different wetting behavior. This prevents the thermal energy of the metal melt from being reduced by the direct contact with the surface texture of the casting mold. As a result, the metal melt flows further than melt that has direct contact with an unstructured casting surface.

The result is that the projecting or recessed structures create a surface texture that breaks up the oxide film that forms while the melt front flows. In addition, the surface tension of the melt front is reduced in a purposeful way. This makes it possible to increase the flow length of the melt for the same wall thickness of the cast article or to reduce the wall thickness of the cast article for the same flow length. Of course, a combination of increased flow length and decreased wall thickness is also possible. This results in a reduction of the melt required, and the cast article that is produced can also have smaller wall thicknesses of less than 5 mm. In consequence, the overall weight of the cast article is reduced and is optimized with respect to lightweight construction. The properties of the cast article that is produced are not adversely affected by the surface texture introduced into the casting mold. The surface textures can be used in casting molds for producing cast articles from light metal, for example from aluminum, in particular in gravity casting, tilt casting, CPC casting (counter-pressure casting), low-pressure casting, and die casting.

An embodiment of the casting mold makes provision that the elementary cells of the surface texture form a pattern with identically designed structures. Because the surface texture forms a pattern with identical structures, the manufacturing effort to introduce the surface texture into the casting surface of the casting mold is minimized, in particular. An additional result is that the same effects act on the metal melt and the melt front in the entire region of the surface texture. Of course, it is also possible for the surface texture to form a pattern of different structures. While the manufacturing effort is greater in this case, it is possible in return to achieve different effects in individual regions depending on the complexity of the cast article.

In addition, it can be advantageous for all elementary cells of the surface texture to have the same size and/or shape. However, it is likewise possible for the elementary cells to have different shapes or sizes, especially when different effects are to be achieved in certain areas of the casting mold. It can also be useful for two or more elementary cells of the surface texture to overlap at least partially. In this way, a spacing of the structures of adjacent elementary cells can be varied as a function of the structure of the cast article or of the complexity of the cavity of the casting mold in order to achieve or intensify certain effects.

An embodiment of the present invention makes provision for the structure to be spherical in design. The spherical, in particular hemispherical, recess in the applicable elementary cells produces a surface texture similar to a golf ball structure. As a result of the so-called golf ball effect, the frictional resistance due to the casting surface itself is decreased by a reduction of the contact area, and the flow velocity of the metal melt and thus also the flow length of the metal melt are increased. A structure of this type is also referred to as a non-directional structure, and can be employed anywhere that a flow of the metal melt that is slow and undefined with regard to direction is preferably to be expected.

An embodiment of the casting mold is also achieved by the means that the structure has at least one bump or recess that extends in the direction of flow of a metal melt in the cavity. Directional structures of this nature are used, in particular, at points in the casting mold where a preferably rapid and strongly directed flow is to be expected. The elongated structures oriented in the direction of flow hinder the transverse motion of the vortices in the turbulent flow at the surface of the casting surface. In this way, the wall friction is reduced by approximately 10%. This reduction in resistance results in an increase in the flow length of the metal melt of approximately 50%.

The effects of the introduced structures can be influenced or intensified and adapted to the applicable boundary conditions by the means that the at least one bump or recess has different widths and/or different heights or depths. A single recess can thus have sections along its longitudinal extent whose dimensions differ from the sections adjacent to it in the same recess. In this design, the transition between the applicable adjacent sections can have steps or be continuous.

It has proven to be especially practical for the structures to have two or more bumps and/or recesses. Depending on the application, they can have bumps and/or recesses that are not connected to one another or else can include a connected structure.

In this case, the bumps and/or recesses of the structure can be arranged to be parallel to one another or else can together enclose an acute angle. Of course, the at least two or more bumps and/or recesses of a structure can also have different lengths and/or different widths and/or different heights and/or different depths from one another. Also, the distances between the recesses or bumps can be adapted to the particular application case.

Moreover, it has proven to be especially advantageous in practice for the structure to be a bionic structure. In this context, the structure can be designed to be similar to the scales of a shark's skin, for example. The scales here have various ribs, oriented in the direction of flow of the metal melt, with a sharp rib apex. The ribs have different lengths, depths, and widths. The structure can also be designed in the manner of a crow's foot or as a bamboo structure.

Also provided according to the invention is a casting mold having a cavity for manufacturing a cast article in which at least some areas of a casting surface of the casting mold delimiting the cavity have a surface texture that has multiple elementary cells, wherein each elementary cell has a structure that projects or is recessed with respect to the casting surface, wherein the structures of elementary cells that are adjacent to one another are connected in design and form a pattern of orthogonal bumps or recesses, wherein a ratio between the casting surface and a projecting or recessed structure surface within an elementary cell is less than 2:1. As a result of the fact that more than one third of the elementary cell has recesses or bumps, similar effects occur as with the structures that end within the elementary cells. Due to the orthogonality of the bumps or recesses, they can be introduced into the casting surface of the casting mold especially quickly and easily.

It has proven advantageous in this context for a height and/or depth of the bumps or recesses to correspond to half the distance between two parallel bumps and/or parallel recesses in adjacent elementary cells and for the bumps or recesses to have a semicircular or V-shaped cross-section.

A further simplification in the manufacture of the surface texture is also achieved by the means that the orthogonal bumps or recesses of the pattern of the surface texture have a constant height or depth.

In the case of simple structures within the elementary cells, it proves useful for the surface texture or the structure in the applicable elementary cells to be produced by a machining process. Mentioned by way of example here is the production of track-like structures by a ball end mill. The use of a machining process precludes thermal influence on the casting mold material while the structure is being introduced. Depending on the design of the surface texture, it can also be produced by a forming process, in particular by compression forming or embossing.

In the case of complex structures, in contrast, it proves useful for the surface texture to be produced by a non-traditional material removal process. Here, the structure is introduced into the casting surface of the casting mold by a laser, for example. Mentioned here as a complex structure by way of example is the production of the riblets of the shark structure.

An embodiment of the casting mold provides that at least two surface textures that have the same pattern or different patterns are arranged on the casting surface of the casting mold. Depending on location-dependent flow conditions, different patterns with different structures are used in the corresponding regions of the casting mold for a cast article to be produced. For example, in regions with fast, strongly directional flow, a unidirectional structure is more advantageous in which the applicable structure is oriented essentially in the direction of flow of the metal melt. In regions through which a more undefined direction of flow passes slowly, in contrast, the non-directional structures are advantageous. These structures should also be preferred in the case of changes in flow direction during filling of the mold. The surface textures are thus selected in different regions of the casting mold such that they achieve the best effect locally.

In this context, the flow velocity and also the flow direction in the casting mold can be precisely predicted in advance through a casting simulation. This information can then be used to determine (by an automated process, where applicable) the optimal direction of the structures on the casting surface. To this end, it is necessary to store a parameter field (speed and direction) in the simulation. This procedure is needed in order to make full use of the effects of unidirectional structures.

In addition, the invention relates to a cast part produced in a casting mold described above. In this context, the cast part has the negative contour of the surface texture arranged in the casting mold.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a cast article according to the invention in a perspective view;

FIG. 2 is a schematic diagram of a casting mold according to the invention;

FIG. 3 illustrates a surface texture in the casting surface of the casting mold in a view corresponding to A-A in FIG. 2;

FIGS. 4a to 4e illustrate various arrangements of elementary cells to form a surface texture;

FIGS. 5a to 5f illustrate an embodiment of a surface texture;

FIGS. 6a to 6f illustrate an embodiment of a surface texture;

FIGS. 7a to 7f illustrate an embodiment of a surface texture;

FIGS. 8a to 8f illustrate an embodiment of a surface texture;

FIGS. 9a to 9f illustrate an of a surface texture;

FIG. 10 illustrates an embodiment of a surface texture; and

FIGS. 11a to 11f illustrate an embodiment of the surface texture.

### DETAILED DESCRIPTION

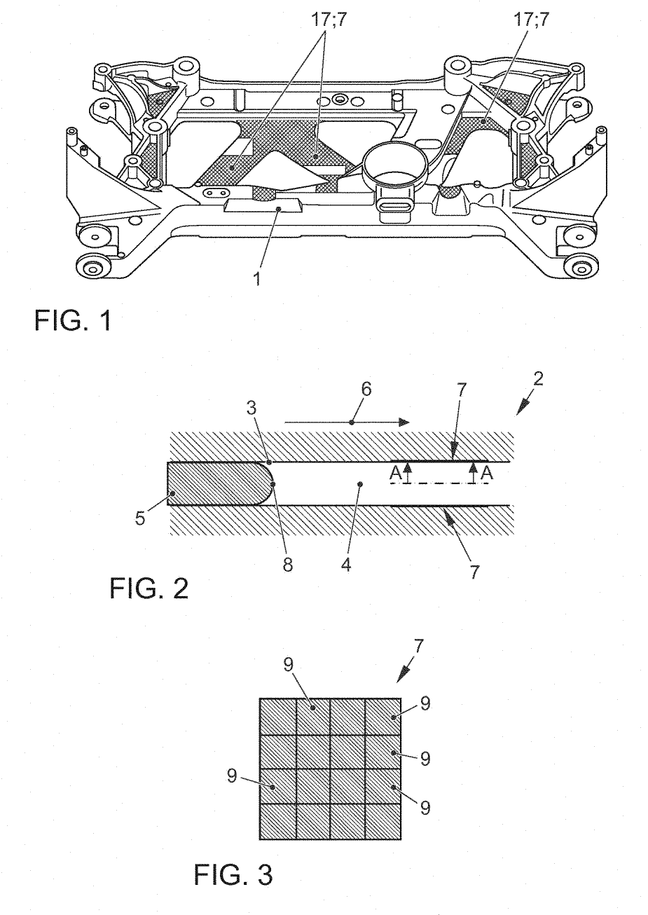

A casting mold 2 shown in FIG. 2 in a schematic diagram is provided for the purpose of producing a cast article 1, shown in FIG. 1 and implemented as a chassis part, from aluminum or an aluminum alloy by means of a casting process.

The casting mold 2, implemented as a permanent mold, has a cavity 4 that is delimited by casting surfaces 3 and into which a liquid or fluid metal melt 5 of aluminum is poured during the course of the casting process, which melt then moves continuously in a flow direction 6 in the cavity 4. At least some areas of the substantially smooth casting surfaces 3 have a surface texture 7. FIG. 2 shows the point in time of the casting process when a melt front 8 of the metal melt 5 has not yet reached the region where the surface texture 7 is arranged.

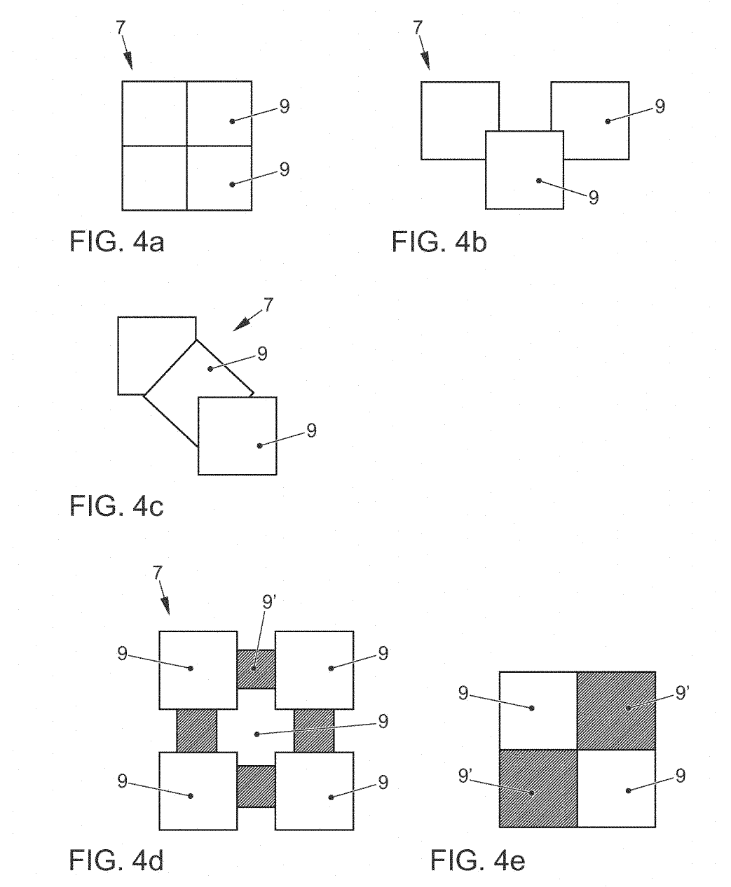

FIG. 3 shows the surface texture 7 represented in FIG. 2 in a view corresponding to line A-A in FIG. 2. The surface texture 7 has a plurality of elementary cells 9 arranged next to or beneath one another and forming a pattern, which cells are, in particular, square in design. FIGS. 4a) to e) show examples of a possible arrangement of the elementary cells 9 within the surface texture 7. To form the surface texture 7, the elementary cell 9 is repeated by inversion, displacement, rotation, or mirror-imaging. During the process, the elementary cells 9 can also at least partially overlap one another. Preferably, all elementary cells 9 forming a surface texture 7 are identical in design. It is also possible, however, for a surface texture 7 to has a combination of different elementary cells 9, 9′ that differ with regard to size and/or shape. The edge length of the elementary cells 9 is preferably less than 10 mm.

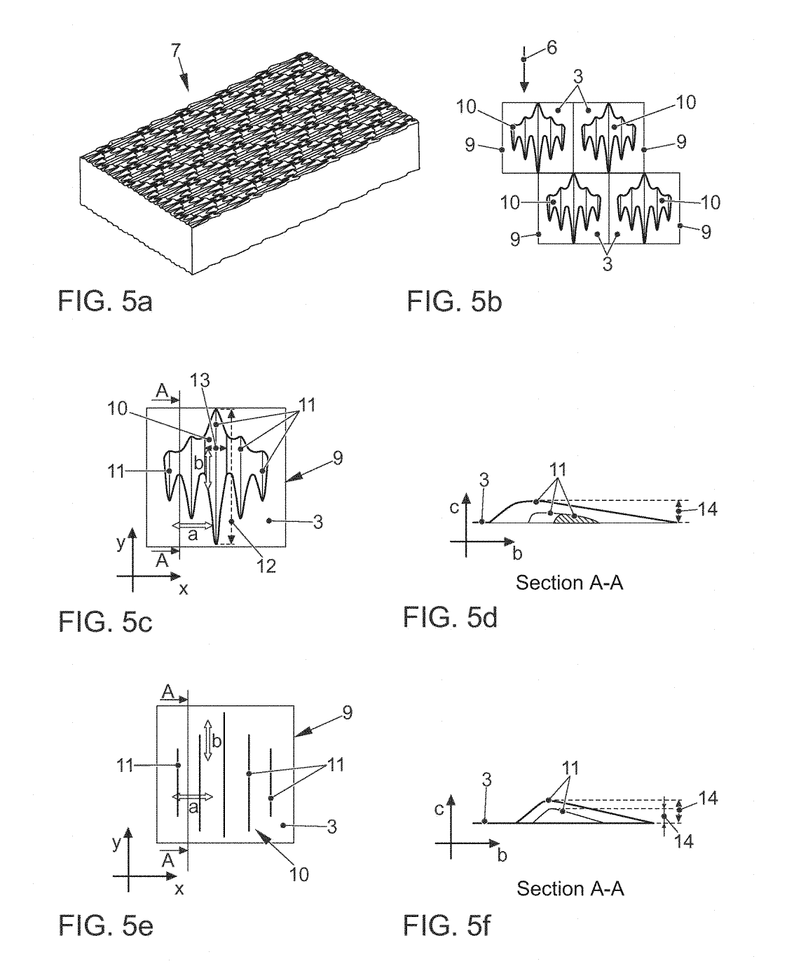

According to the invention, provision is made that each elementary cell 9 has a structure 10 that projects and/or is recessed with respect to a base level of the casting surface 3 and ends within the applicable elementary cell 9. FIGS. 5 to 10 show different embodiments of the surface textures 7 in different views a) to f). The views 5a) to 10a) show a section of the applicable surface texture 7 in the casting surface 3 of the casting mold 2 in a perspective representation. A top view of the surface texture 7 shown in the views 5a) to 10a) and an orientation of the structures 10 relative to the flow direction 6 of the metal melt 5 are represented in the views 5b) to 10b).

The views 5c) to 10c) each show an individual elementary cell 9 spanned by the x-axis and the y-axis with the applicable structure 10. An orientation of the structure 10 within the elementary cell 9 and relative to the flow direction 6 of the metal melt 5 is represented by the two principal directions a and b. A cross-sectional view along the line A-A in the views 5c) to 10c) is illustrated in views 5d) to 10d). Views 5e) to 10e) show the technically simplified structures 10 from views 5c) to 10c), and the views 5f) to 10f) show the applicable cross-sectional representation along the line A-A in the views 5e) to 10e).

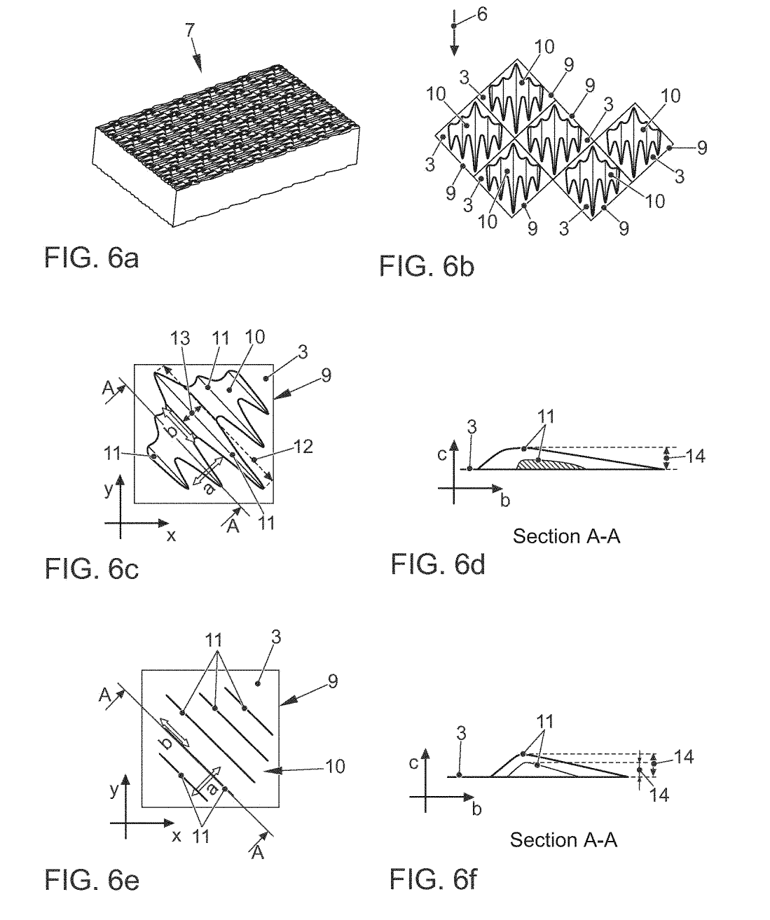

The surface textures 7 shown in FIGS. 5 and 6 each have, within an elementary cell 9, a structure 10 that is raised with respect to the base level of the casting surface 3, has multiple bumps 11, and is similar in design to a scale of a shark's skin. Generally speaking, this structure 10 within the elementary cell 9 can also be designed as the inverse, and has multiple recesses set back with respect to the base level of the casting surface 3. The illustrated structure 10 within each elementary cell 9 has a total of five tapered bumps 11 arranged next to one another that extend in the principal direction b within the elementary cell 9. As can be seen in views 6c) and 6d, the bumps 11 have different lengths 12, widths 13, and heights 14. In the embodiment from FIG. 5, the principal direction b of the structure 10 is parallel to the y-axis, and in the embodiment from FIG. 6, the structure 10 is oriented at an angle of 45° to the y-axis. The elementary cells 9 of the two embodiments are arranged such that the principal direction b of the structures 10 within the elementary cells 9 extends in the direction of flow 6 of the metal melt 5, as is evident from the views 5b) and 6b). In the embodiment from FIG. 6, this results in a smaller distance between the individual structures 10 of the applicable adjacent elementary cells 9 as compared to the embodiment in FIG. 5, and consequently a higher packing density within the overall surface texture 7.

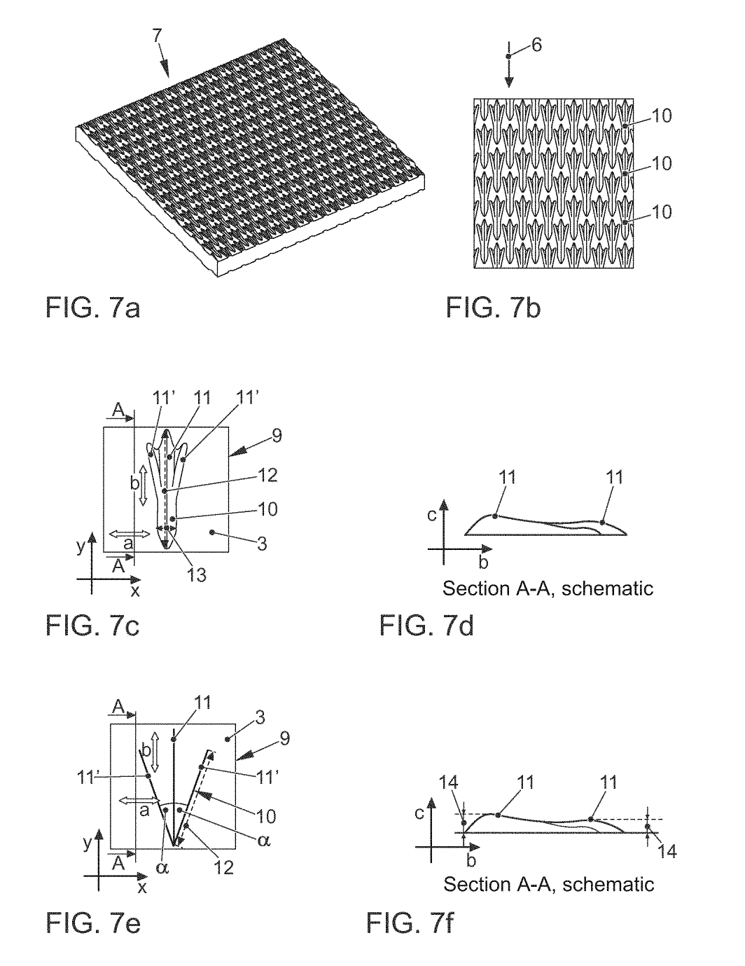

Another embodiment of the surface texture 7 is shown in FIG. 7. The elementary cells 9 of this surface texture 7 each have a structure 10 that is raised with respect to the base level of the casting surface 3, has multiple connected bumps 11, and is similar in design to a crow's foot. The structure 10 has a central bump 11 oriented in the principal direction b, and two bumps 11′ that are angled at an acute angle α therefrom. The bumps 11, 11′ have different lengths 12, widths 13, and heights 14. The elementary cells 9 can be arranged next to and beneath one another at the same height, or as shown in view 7b), can be offset from one another in the direction of flow 6 of the metal melt 5. This ensures a higher packing density of the structures 10 within the surface texture 7.

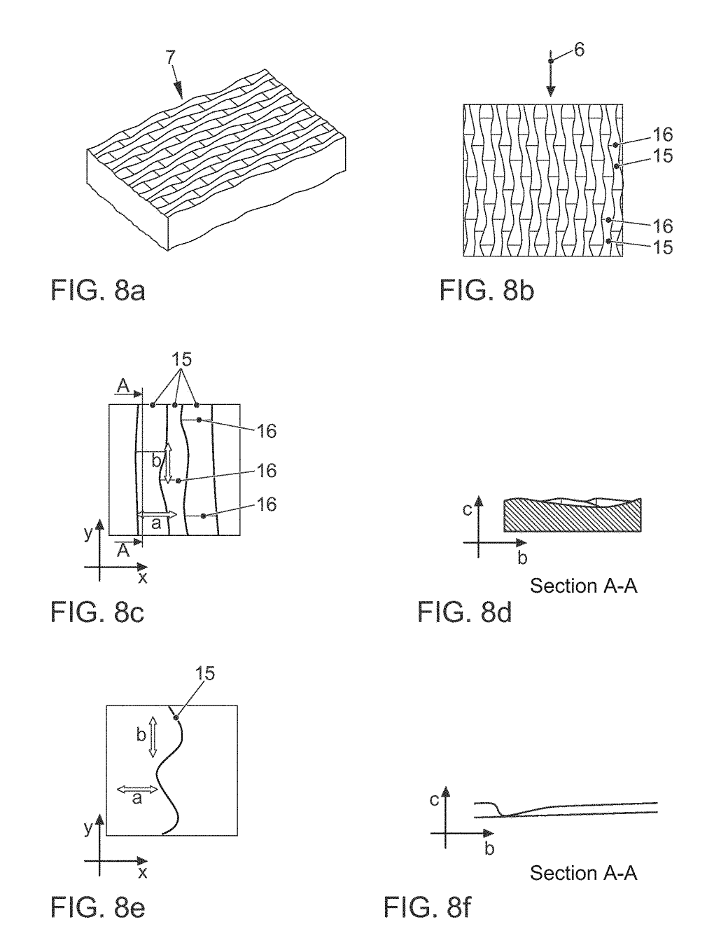

Another embodiment of a structure 10 oriented in the direction of flow 6 is shown in FIG. 8. Here, the structure 10 has multiple impressions of a bamboo stalk 15 oriented in the flow direction 6, arranged next to one another and partially overlapping. The joints 16 of the bamboo stalk 15 are arranged offset from one another in the flow direction 6. This results in an undulating, sinusoidal shape of the structure 10 (view 8e)).

The structures 10 described in FIGS. 5 through 8 are directional, so-called unidirectional, structures 10 which preferably are employed in regions with rapid, strongly directed flow of the metal melt 5. The applicable structure 10 in this case is oriented substantially in the direction of flow 6 of the metal melt 5.

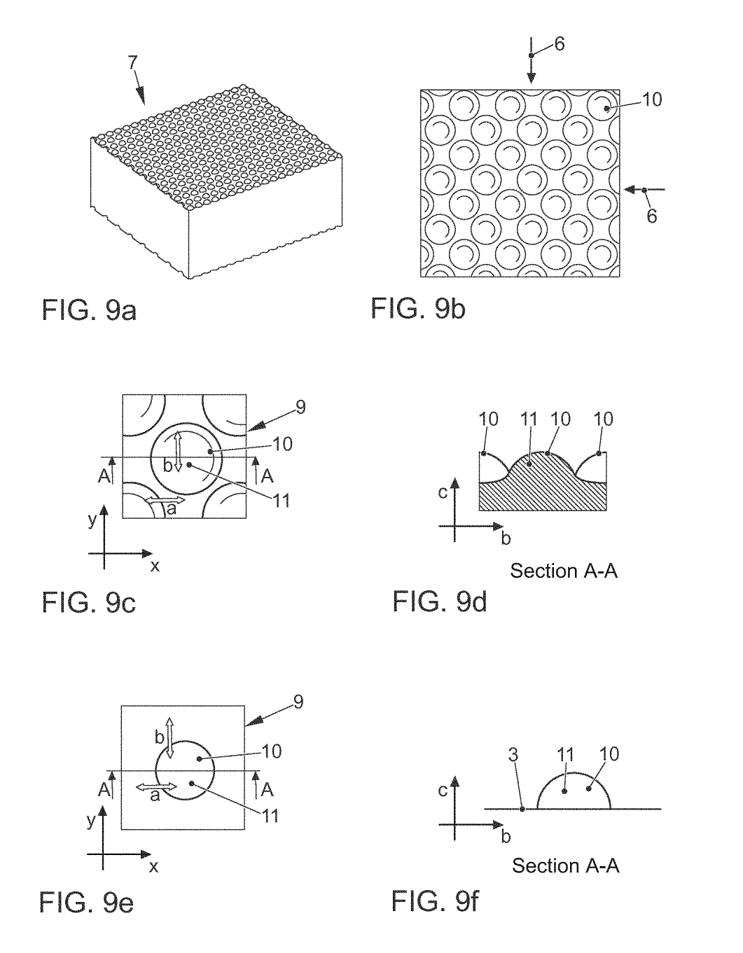

Another embodiment of the surface texture 7 is shown in FIG. 9. Here, the structure 10 within the elementary cell 9 is designed as a spherical, in particular hemispherical, bump 11. Because of the symmetry of the bump 11, this structure 10 is called a non-directional structure 10, which can be arranged or oriented independently of the expected flow direction 6 of the metal melt 5. A surface texture 7 with such non-directional structures 10 is employed in particular in regions of the cavity 4 through which flow passes slowly with a flow direction 6 that tends to be undefined or in the case of changes in flow direction during mold filling.

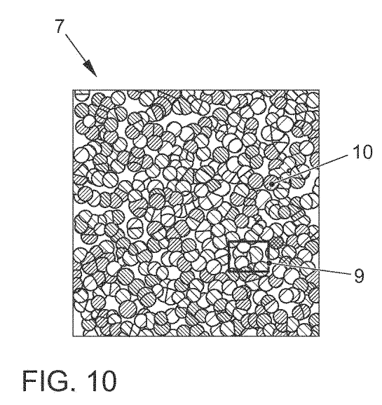

In FIG. 10, another embodiment of the surface texture 7 is shown that likewise has non-directional structures 10. The structures 10 are likewise spherical or hemispherical in design, and can be implemented as a bump or a recess. In this design, the bumps or recesses can each have different heights or depths. Also, more than one hemispherical structure can be present within one elementary cell 9. The structures 10 form a stochastically and/or geometrically definable structured surface.

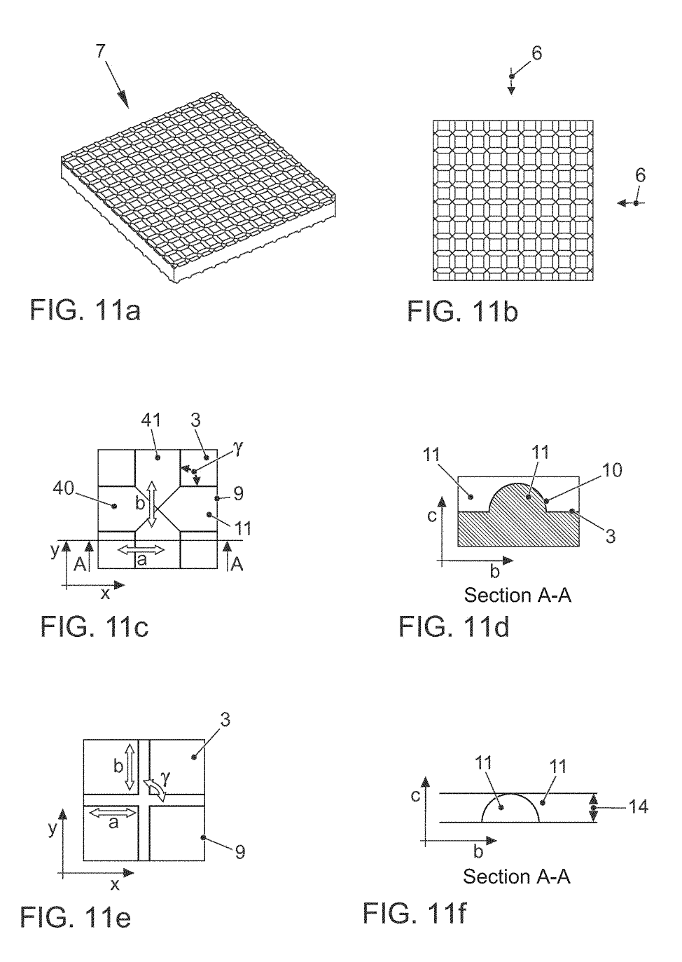

Another embodiment of a surface texture 7 with a non-directional structure 10 is shown in FIG. 11. The surface texture 7 likewise has multiple elementary cells 9, wherein each elementary cell 9 has a structure 10 that projects with respect to the casting surface 3. The structures 10 of applicable adjacent elementary cells 9 are connected in design, and form a pattern of orthogonal bumps 11 that enclose an angle γ of 90° (view 10e)). Here, a ratio between the casting surface 3 and the projecting structure surface within an elementary cell 9 is less than 2:1. As can be seen in views 10d) and 10f), the bumps 11 have a semicircular cross-section. A height 14 of the bumps 11 corresponds approximately to half the distance between two parallel bumps 11 in adjacent elementary cells 9. The orthogonally arranged bumps 11 of the pattern of the surface texture 7 have a constant height 14.

As can be seen in FIG. 1, the cast article 1 produced in the casting mold 2 according to the invention has a negative shape 17 of the surface texture 7 of the casting mold 2. Depending on the geometry of the cast article and the prevailing flow directions 6 and flow velocities of the metal melt 5 during the casting process, the cast article 1 or the casting mold 2 can have multiple surface textures 7 that are not connected to one another.

In summary, due to the surface texture 7 according to the invention in the casting mold 2, various advantageous effects are brought about that cause the flow length of the metal melt 5 in the casting mold 2 during the casting process to be extended. In consequence, cast articles 1 with wall thicknesses less than 5 mm can be produced.

Because of the structures 10 in the elementary cells 9, a so-called air cushion effect arises due to locally generated air vortex zones, with the air cushions between the metal melt 5 and the casting mold 2 acting as an insulator for the thermal and tribological transition. In this way, the flow length and the flow velocity of the metal melt 5 can be controlled in a directed way.

Also arising because of the structure 10 is the so-called radiator effect, in which the cooling rate and the cooling direction are influenced in a specific way through local cooling effects, and which leads to a specific reduction and to a specific fracturing of the oxide film forming on the metal melt 5 during the casting process.

The flow direction 6 and the flow velocity, as well as the solidification rate of the metal melt 5, are controlled in a directed way through the design of the structure 10 and the arrangement of the elementary cells 9 within the surface texture 7. Moreover, the roughness grade of the surface of the casting mold 2 produced by the structures 10 provides for a constant fracturing of the oxide film of the metal melt 5 and thus for a lengthening of the flow path of the metal melt 5 within the cavity 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A casting mold comprising:
at least one cavity for manufacturing at least one cast article;
a surface texture formed on at least a portion of a casting surface of the casting mold delimiting the cavity, the surface texture having a plurality of elementary cells; and
air cushions formed between a metal melt and the casting mold;
wherein each of the plurality of elementary cells has a structure that projects and/or is recessed with respect to the casting surface and ends within the applicable elementary cell,
wherein the casting mold is a permanent mold,
wherein the elementary cells of the surface texture form a pattern with substantially identically designed structures,
wherein all of the plurality of elementary cells of the surface texture have substantially the same size and/or shape, and
wherein the surface texture is formed by a laser on the portion of the casting surface.

2. The casting mold according to claim 1, wherein two or more elementary cells of the surface texture overlap at least partially.

3. The casting mold according to claim 1, wherein the structure is spherical.

4. The casting mold according to claim 1, wherein the structure has at least one bump or recess that extends in a flow direction of the metal melt in the cavity.

5. The casting mold according to claim 4, wherein the at least one bump or recess have different widths or different heights or depths.

6. The casting mold according to claim 1, wherein the structure has two or more bumps or recesses that are not connected to one another or that form a connected structure.

7. The casting mold according to claim 4, wherein the bumps or recesses of the structure are arranged to be parallel to one another.

8. The casting mold according to claim 1, wherein the structure has two or more connected bumps or recesses that together enclose an acute angle.

9. The casting mold according to claim 8, wherein the at least two or more bumps or recesses of the structure have different lengths or different widths or different heights or different depths.

10. The casting mold according to claim 1, wherein the structure is a bionic structure.

11. A casting mold comprising:
a surface texture that includes a plurality of elementary cells; and
at least one cavity for manufacturing at least one cast article in which at least some areas of a casting surface of the casting mold delimiting the cavity have the surface texture,
wherein each elementary cell has a structure that projects or is recessed with respect to the casting surface,
wherein the structures of the elementary cells that are adjacent to one another are connected in design and form a pattern of orthogonal bumps or recesses,
wherein a ratio between the casting surface and a projecting or recessed structure surface within an elementary cell is less than 2:1,
wherein air cushions are formed between a metal melt and the casting mold, and
wherein the surface texture is produced by a material removal process via a laser on the at least some areas of the casting surface.

12. The casting mold according to claim 11, wherein the structure has bumps or recesses, wherein a height or depth of the bumps or recesses corresponds to half a distance between two parallel bumps or parallel recesses in adjacent elementary cells.

13. The casting mold according to claim 11, wherein the bumps or recesses have a semicircular or V-shaped cross-section.

14. The casting mold according to claim 11, wherein the orthogonal bumps or recesses of the pattern of the surface texture have a constant height or depth.

15. The casting mold according to claim 11, wherein the surface texture is produced by a machining process.

16. The casting mold according to claim 11, wherein at least two surface textures that have the same pattern or different patterns are arranged on the casting surface of the casting mold.

17. The casting mold according to claim 11, wherein the casting mold is a permanent mold.

18. A cast article produced in a casting mold according to claim 1.
